(19) United States
(12) Patent Application Publication
(10) Pub. No.: US 2025/0380076 A1
(43) Pub. Date: Dec. 11, 2025

(54) Bone Conduction Microphone

(71) Applicant: AAC ACOUSTIC TECHNOLOGIES (SHENZHEN) CO., LTD., Shenzhen (CN)

(72) Inventors: Kaijie Wang, Shenzhen (CN); Qiang Dan, Shenzhen (CN); Shitao Yan, Shenzhen (CN)

(21) Appl. No.: 19/001,521

(22) Filed: Dec. 25, 2024

Related U.S. Application Data
(63) Continuation of application No. PCT/CN2024/097642, filed on Jun. 6, 2024.

(51) Int. Cl. H04R 1/08

(52) U.S. Cl. CPC H04R 1/08; H04R 2460/13

(57) ABSTRACT

A bone conduction microphone is disclosed. The bone conduction microphone includes a substrate having a cavity with two end openings, a backplate disposed above the substrate, a vibration structure disposed between the backplate and the substrate, and a limiter for limiting a maximum displacement of the vibration structure. The vibration structure includes a diaphragm disposed between the backplate and the substrate and arranged at intervals with the backplate and the substrate respectively and a mass block suspended by the diaphragm and inserted into the cavity through one end opening of the cavity. The bone conduction microphone improves the reliability.

### FIELD OF THE PRESENT DISCLOSURE

The present disclosure relates to microphones, in particular to a bone conduction microphone.

### DESCRIPTION OF THE RELATED ART

Bone conduction microphones convert slight vibrations of bones of the head and neck caused by human voice into electrical signals. Unlike traditional microphones collecting sounds through air conduction, bone conduction microphones can restore sounds with high definition even when used in noisy environments, so as to avoid the noise interference caused by airborne sounds and ensure the sound quality extremely high.

However, a bone conduction microphone in the related art is unable to limit a maximum displacement of a vibration structure therein, and an excessive displacement of the vibration structure is likely to cause damage to the vibration structure. As a result, the reliability of the bone conduction microphone in the related art is not good, especially when testing the reliability of the bone conduction microphone in the related art, the vibration structure is very easy to be damaged.

Thus, it is necessary to provide a novel bone conduction microphone to solve the problems.

### SUMMARY

An objective of the present disclosure is to overcome the above problems and provide a bone conduction microphone which improves the reliability.

In order to achieve the objective mentioned above, the present disclosure discloses a bone conduction microphone including a substrate having a cavity with two end openings, a backplate disposed above the substrate, a vibration structure disposed between the backplate and the substrate, and a limiter for limiting a maximum displacement of the vibration structure. The vibration structure includes a diaphragm disposed between the backplate and the substrate and arranged at intervals with the backplate and the substrate respectively and a mass block suspended by the diaphragm and inserted into the cavity through one end opening of the cavity.

As an improvement, the limiter is a first protrusion arranged on a side of the backplate facing the diaphragm for limiting the maximum displacement of the vibration structure towards the backplate.

As an improvement, the limiter is a second protrusion arranged on a side of the diaphragm facing the backplate for limiting the maximum displacement of the vibration structure towards the backplate.

As an improvement, the limiter is a third protrusion arranged on a side of the mass block away from the diaphragm for limiting the maximum displacement of the vibration structure away from the backplate.

As an improvement, the bone conduction microphone further includes a mounting plate. The substrate is mounted on the mounting plate, and the mounting plate covers another end opening of the cavity. The limiter is a fourth protrusion disposed in the cavity and arranged on a side of the mounting plate facing the vibration structure. The fourth protrusion faces and is spaced apart from the mass block for limiting the maximum displacement of the vibration structure away from the backplate.

As an improvement, the bone conduction microphone further includes a mounting plate. The substrate is mounted on the mounting plate, and the mounting plate covers another end opening of the cavity. The diaphragm, the substrate and the mounting plate together form a sealed space. The limiter is the sealed space for limiting the maximum displacement of the vibration structure away from the backplate.

As an improvement, the substrate includes a main body part forming the cavity and a sub part disposed in the cavity and arranged at intervals with the main body part. At least part of the mass block is formed by the sub part.

As an improvement, a side of the sub part away from the diaphragm is provided with a fifth protrusion. The limiter is the fifth protrusion for limiting the maximum displacement of the vibration structure away from the backplate.

In the bone conduction microphone according to the present disclosure, the limiter can limit the maximum displacement of the vibration structure so as to avoid the vibration structure being damaged by the excessive displacement of the vibration structure and improve the reliability.

### BRIEF DESCRIPTION OF THE DRAWINGS

In order to more clearly illustrate the technical solutions in embodiments of the present disclosure, the accompanying drawings used in the description of the embodiments will be briefly introduced below. It is apparent that, the accompanying drawings in the following description are only some embodiments of the present disclosure, and other drawings can be obtained by those of ordinary skill in the art based on the accompanying drawings without creative efforts, wherein:

FIG. 1 is a cross-sectional view of a first bone conduction microphone of the present disclosure.

FIG. 2 is a cross-sectional view of a second bone conduction microphone of the present disclosure.

FIG. 3 is a cross-sectional view of a third bone conduction microphone of the present disclosure.

FIG. 4 is a cross-sectional view of a fourth bone conduction microphone of the present disclosure.

FIG. 5 is a cross-sectional view of a fifth bone conduction microphone of the present disclosure.

FIG. 6 is a cross-sectional view of a sixth bone conduction microphone of the present disclosure.

### DETAILED DESCRIPTION OF THE EMBODIMENTS

The technical solutions in embodiments of the present disclosure will be described clearly and completely below with reference to the accompanying drawings in the embodiments of the present disclosure. It is apparent that, the described embodiments are merely some of rather than all of the embodiments of the present disclosure. All other embodiments acquired by those of ordinary skill in the art without creative efforts based on the embodiments of the present disclosure shall fall within the protection scope of the present disclosure.

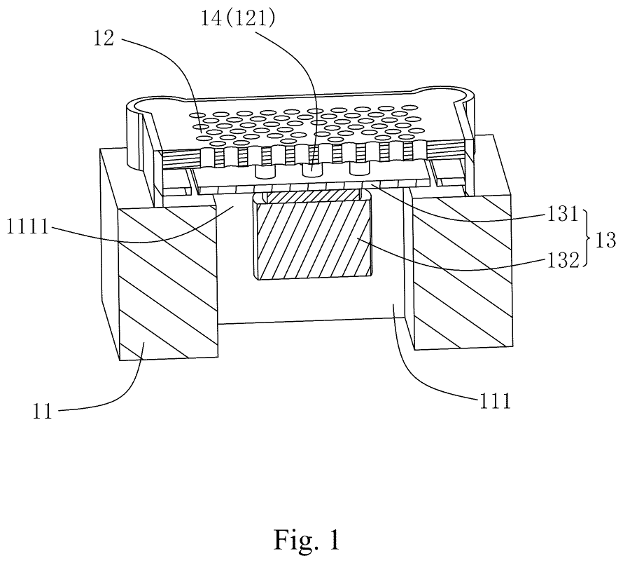

Referring to FIG. 1, the present disclosure discloses a first bone conduction microphone 100 including a substrate 11 having a cavity 111 with two end openings, a backplate 12 disposed above the substrate 11, and a vibration structure 13 disposed between the backplate 12 and the substrate 11.

The vibration structure 13 includes a diaphragm 131 disposed between the backplate 12 and the substrate 11 and arranged at intervals with the backplate 12 and the substrate 11 respectively and a mass block 132 suspended by the diaphragm 131 and inserted into the cavity 111 through one end opening 1111 of the cavity 111.

The first bone conduction microphone 100 further includes a limiter 14 for limiting a maximum displacement of the vibration structure 13 towards the backplate 12. The limiter 14 is a first protrusion 121 arranged on a side of the backplate 12 facing the diaphragm 131.

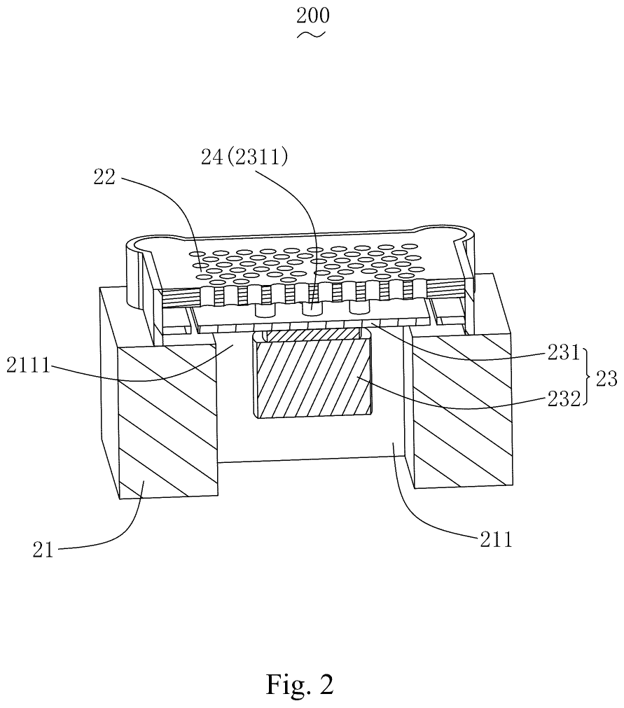

Referring to FIG. 2, the present disclosure discloses a second bone conduction microphone 200 including a substrate 21 having a cavity 211 with two end openings, a backplate 22 disposed above the substrate 21, and a vibration structure 23 disposed between the backplate 22 and the substrate 21.

The vibration structure 23 includes a diaphragm 231 disposed between the backplate 22 and the substrate 21 and arranged at intervals with the backplate 22 and the substrate 21 respectively and a mass block 232 suspended by the diaphragm 231 and inserted into the cavity 211 through one end opening 2111 of the cavity 211.

The second bone conduction microphone 200 further includes a limiter 24 for limiting a maximum displacement of the vibration structure 23 towards the backplate 22. The limiter 24 is a second protrusion 2311 arranged on a side of the diaphragm 231 facing the backplate 22.

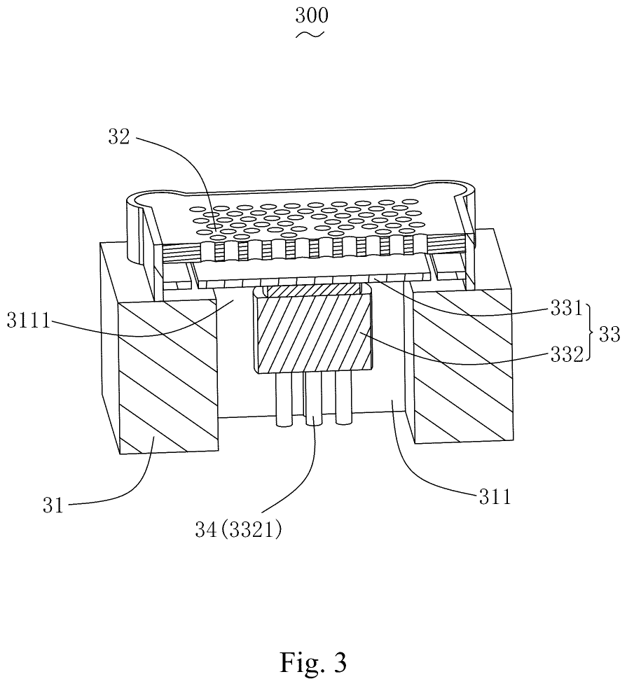

Referring to FIG. 3, the present disclosure discloses a third bone conduction microphone 300 including a substrate 31 having a cavity 311 with two end openings, a backplate 32 disposed above the substrate 31, and a vibration structure 33 disposed between the backplate 32 and the substrate 31.

The vibration structure 33 includes a diaphragm 331 disposed between the backplate 32 and the substrate 31 and arranged at intervals with the backplate 32 and the substrate 31 respectively and a mass block 332 suspended by the diaphragm 331 and inserted into the cavity 311 through one end opening 3111 of the cavity 311.

The third bone conduction microphone 300 further includes a limiter 34 for limiting a maximum displacement of the vibration structure 33 away from the backplate 32. The limiter 34 is a third protrusion 3321 arranged on a side of the mass block 332 away from the diaphragm 331.

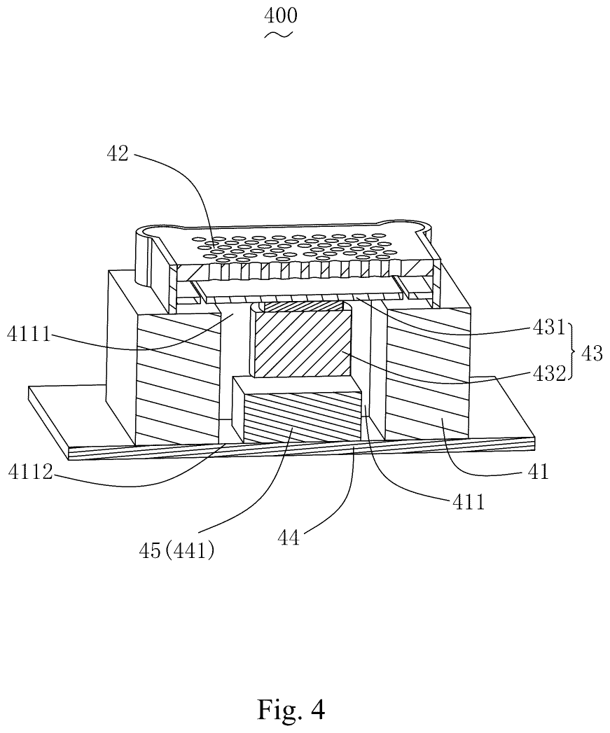

Referring to FIG. 4, the present disclosure discloses a fourth bone conduction microphone 400 including a substrate 41 having a cavity 411 with two end openings, a backplate 42 disposed above the substrate 41, a vibration structure 43 disposed between the backplate 42 and the substrate 41, and a mounting plate 44.

The vibration structure 43 includes a diaphragm 431 disposed between the backplate 42 and the substrate 41 and arranged at intervals with the backplate 42 and the substrate 41 respectively and a mass block 432 suspended by the diaphragm 431 and inserted into the cavity 411 through one end opening 4111 of the cavity 411.

The substrate 41 is mounted on the mounting plate 44, and the mounting plate 44 covers another end opening 4112 of the cavity 411.

The fourth bone conduction microphone 400 further includes a limiter 45 for limiting a maximum displacement of the vibration structure 43 away from the backplate 42. The limiter 45 is a fourth protrusion 441 disposed in the cavity 411 and arranged on a side of the mounting plate 44 facing the vibration structure 43. The fourth protrusion 441 faces and is spaced apart from the mass block 432.

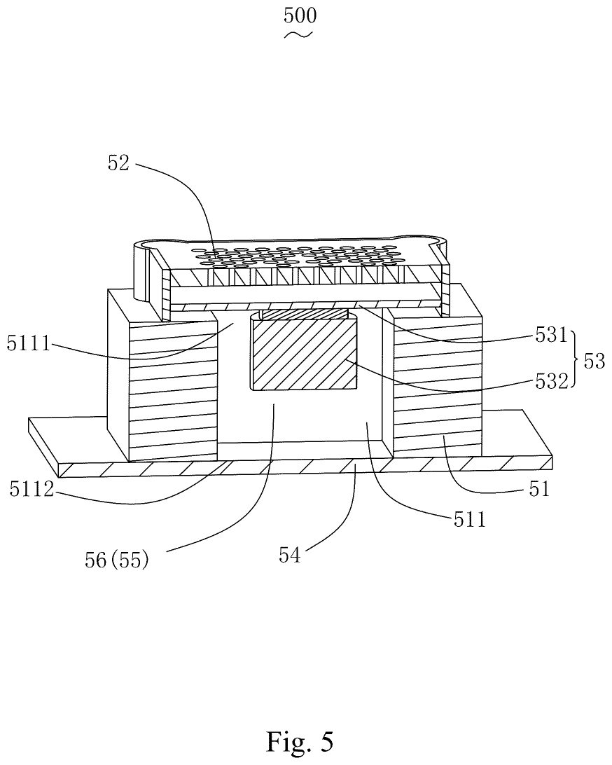

Referring to FIG. 5, the present disclosure discloses a fifth bone conduction microphone 500 including a substrate 51 having a cavity 511 with two end openings, a backplate 52 disposed above the substrate 51, a vibration structure 53 disposed between the backplate 52 and the substrate 51, and a mounting plate 54.

The vibration structure 53 includes a diaphragm 531 disposed between the backplate 52 and the substrate 51 and arranged at intervals with the backplate 52 and the substrate 51 respectively and a mass block 532 suspended by the diaphragm 531 and inserted into the cavity 511 through one end opening 5111 of the cavity 511.

The substrate 51 is mounted on the mounting plate 54, and the mounting plate 54 covers another end opening 5112 of the cavity 511. The diaphragm 531, the substrate 51 and the mounting plate 54 together form a sealed space 55.

The fifth bone conduction microphone 500 further includes a limiter 56 for limiting a maximum displacement of the vibration structure 53 away from the backplate 52. The limiter 56 is the sealed space 55, the air in the sealed space 55 is compressed when the vibration structure 53 moves away from the backplate 52, thereby impeding the movement of the vibration structure 53 away from the backplate 52.

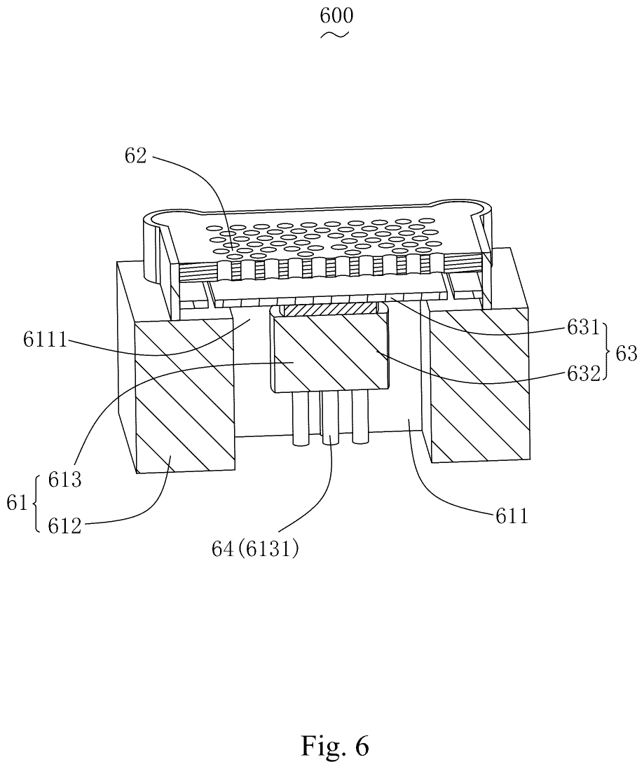

Referring to FIG. 6, the present disclosure discloses a sixth bone conduction microphone 600 including a substrate 61 having a cavity 611 with two end openings, a backplate 62 disposed above the substrate 61, and a vibration structure 63 disposed between the backplate 62 and the substrate 61.

The vibration structure 63 includes a diaphragm 631 disposed between the backplate 62 and the substrate 61 and arranged at intervals with the backplate 62 and the substrate 61 respectively and a mass block 632 suspended by the diaphragm 631 and inserted into the cavity 611 through one end opening 6111 of the cavity 611.

The substrate 61 includes a main body part 612 forming the cavity 611 and a sub part 613 disposed in the cavity 611 and arranged at intervals with the main body part 612. At least part of the mass block 632 is formed by the sub part 613, thus, the at least part of the mass block 632 is formed when the substrate 61 is formed. It is noted that, this way in which the at least part of the mass block 632 is formed by a part of the substrate 61 in this embodiment can be applied to any bone conduction microphone including any one of the first through fifth bone conduction microphones described above.

The sixth bone conduction microphone 600 further includes a limiter 64 for limiting a maximum displacement of the vibration structure 63 away from the backplate 62. The limiter 64 is a fifth protrusion 6131 provided on a side of the sub part 613 away from the diaphragm 631.

In the bone conduction microphone according to the present disclosure, the limiter can limit the maximum displacement of the vibration structure so as to avoid the vibration structure being damaged by the excessive displacement of the vibration structure and improve the reliability.

The above are only embodiments of the present disclosure. It should be pointed out that those of ordinary skill in the art may also make improvements without departing from the ideas of the present disclosure, all of which fall within the protection scope of the present disclosure.

What is claimed is:

1. A bone conduction microphone, comprising:
a substrate having a cavity with two end openings;
a backplate disposed above the substrate;
a vibration structure disposed between the backplate and the substrate, comprising a diaphragm disposed between the backplate and the substrate and arranged at intervals with the backplate and the substrate respectively and a mass block suspended by the diaphragm and inserted into the cavity through one end opening of the cavity; and
a limiter for limiting a maximum displacement of the vibration structure.

2. The bone conduction microphone as described in claim 1, wherein the limiter is a first protrusion arranged on a side of the backplate facing the diaphragm for limiting the maximum displacement of the vibration structure towards the backplate.

3. The bone conduction microphone as described in claim 1, wherein the limiter is a second protrusion arranged on a side of the diaphragm facing the backplate for limiting the maximum displacement of the vibration structure towards the backplate.

4. The bone conduction microphone as described in claim 1, wherein the limiter is a third protrusion arranged on a side of the mass block away from the diaphragm for limiting the maximum displacement of the vibration structure away from the backplate.

5. The bone conduction microphone as described in claim 1 further comprising a mounting plate, wherein the substrate is mounted on the mounting plate, and the mounting plate covers another end opening of the cavity; the limiter is a fourth protrusion disposed in the cavity and arranged on a side of the mounting plate facing the vibration structure, the fourth protrusion faces and is spaced apart from the mass block for limiting the maximum displacement of the vibration structure away from the backplate.

6. The bone conduction microphone as described in claim 1 further comprising a mounting plate, wherein the substrate is mounted on the mounting plate, and the mounting plate covers another end opening of the cavity; the diaphragm, the substrate and the mounting plate together form a sealed space, the limiter is the sealed space for limiting the maximum displacement of the vibration structure away from the backplate.

7. The bone conduction microphone as described in claim 1, wherein the substrate comprises a main body part forming the cavity and a sub part disposed in the cavity and arranged at intervals with the main body part, at least part of the mass block is formed by the sub part.

8. The bone conduction microphone as described in claim 7, wherein a side of the sub part away from the diaphragm is provided with a fifth protrusion, the limiter is the fifth protrusion for limiting the maximum displacement of the vibration structure away from the backplate.
